(19) United States
(12) Patent Application Publication
(10) Pub. No.: US 2025/0208096 A1
(43) Pub. Date: Jun. 26, 2025

(54) METHOD FOR ANALYSIS, CHARACTERIZATION AND DIRECT QUANTIFICATION OF NAPHTHENIC ACIDS IN PRODUCED WATER

(71) Applicants: PETRÓLEO BRASILEIRO S.A. - PETROBRAS, Rio de Janeiro (BR); UNIVERSIDADE FEDERAL DE GOIÁS - UFG, Goiânia (BR)

(72) Inventors: BONIEK GONTIJO VAZ, Goiânia (BR); IRIS MEDEIROS JUNIOR, Rio de Janeiro (BR); GABRIEL HENRY MORAIS DUFRAYER, Goiânia (BR); GABRIEL FRANCO DOS SANTOS, Goiânia (BR); ROGERIO MESQUITA DE CARVALHO, Rio de Janeiro (BR); BRUNO CHARLES DO COUTO, Rio de Janeiro (BR); MARCELLA FERREIRA RODRIGUES, Goiânia (BR); HERCILIO DE ANGELI HONORATO, Rio de Janeiro (BR); IGOR PEREIRA DA SILVA, Goiânia (BR)

(73) Assignees: PETRÓLEO BRASILEIRO S.A. - PETROBRAS, Rio de Janeiro (BR); UNIVERSIDADE FEDERAL DE GOIÁS - UFG, Goiânia (BR)

(21) Appl. No.: 18/987,344

(22) Filed: Dec. 19, 2024

(30) Foreign Application Priority Data
Dec. 21, 2023 (BR) 1020230271812

(51) Int. Cl. G01N 27/623; G01N 1/28; G01N 1/34; G01N 1/40; G01N 1/44

(52) U.S. Cl. CPC G01N 27/623; G01N 1/286; G01N 1/34; G01N 1/40; G01N 1/44; G01N 2001/2886; G01N 2560/00

(57) ABSTRACT

The present invention relates to a method for analysis, characterization and direct quantification of naphthenic acids n produced water by paper-based ionization mass spectrometry. The method is used in wastewater from the offshore and onshore petrochemical industry, enabling a fast, inexpensive and environmentally friendly analysis for the treatment and proper disposal of wastewater, minimizing problems related to corrosion in pipes and toxicity to the aquatic environment.

### CROSS-REFERENCE FOR RELATED APPLICATIONS

This application claims priority to Brazilian Application No. BR 1020230271812, filed on Dec. 21, 2023, the disclosure of which is herein incorporated by reference in the entirety.

### FIELD OF THE INVENTION

The present invention is part of the field of oil production processes, more precisely in the area of primary processing technologies, and relates to a method for analysis, characterization and direct quantification of naphthenic acids in water produced by paper-based ionization mass spectrometry. The method is used in wastewater from the offshore and onshore petrochemical industry, enabling a fast, inexpensive and environmentally friendly analysis (with almost no use of organic solvents), for the treatment and appropriate disposal of wastewater, minimizing problems related to corrosion in pipes and toxicity to the aquatic environment.

### BACKGROUND OF THE INVENTION

Naphthenic acids (NAs) are natural compounds present in different concentrations in crude oil depending on its origin. Furthermore, these compounds are said to be responsible for the acidity of crude oil. NAs are composed of carboxylic acids, including monocyclic and polycyclic, acyclic and aromatic acids. These compounds are mainly responsible for the corrosion of some oil refinery equipment and are toxic to marine biota, affecting several organisms such as fish, algae, mammals, plants, amphibians, invertebrates, microorganisms and others. Therefore, the characterization of these compounds has been of great interest to the industry in recent years, due to concerns about the presence of NAs in crude oil and produced water.

Due to the complexity of these samples, the chemical characterization and identification of NAs are facilitated by high-resolution mass spectrometry (HRMS). By HRMS, molecular formulas can be assigned with high confidence to thousands of peaks quickly during the analysis of complex mixtures. However, HRMS analysis of NAs is usually performed in combination with extraction methods, such as solid-phase extraction (SPE) and liquid-liquid extraction. Furthermore, the most widely used methods for characterizing and quantifying NAs in produced water involve, in addition to liquid-liquid extraction or solid-phase extraction (SPE), gravimetric analysis, and/or gas chromatography coupled to mass spectrometry (GC-MS) or liquid chromatography coupled to mass spectrometry (LC-MS). However, although these methodologies are well established and provide high analytical performance, they are very laborious and require a large amount of execution time, as they require lengthy extraction steps, in addition to requiring high sample and solvent consumption, which makes the analyses more expensive and not environmentally friendly. These issues highlight the need to develop faster, cheaper, solvent-efficient, and environmentally friendly analytical techniques for determining NAs in wastewater samples.

A range of ambient mass spectrometry techniques have been developed to meet the above requirements, allowing the analysis of compounds from their native environment with minimal or no sample preparation. Among the most common ambient mass spectrometry techniques, paper spray ionization (PSI) has gained prominence in recent years. However, to date, no method employing the paper spray ionization technique has been used for the characterization and quantification of organic acids in petroleum wastewater, including produced water. Thus, the combination of PSI and ultra-high resolution mass spectrometry emerges as a potential technology for the characterization and quantification of NAs in produced waters.

### STATE OF THE ART

The document in the name of Silva et al., entitled “Direct analysis of naphthenic acids in produced water and crude oil by NH₂-surface-modified wooden-tip electrospray ionization mass spectrometry”, addresses a direct method of analyzing naphthenic acids in produced water and crude oil by electrospray ionization mass spectrometry on a wooden tip modified on the surface with APTES. Although the modified tip is a quick and direct way to analyze naphthenic acids, the wooden tip has difficulties in maintaining an analysis standard due to the difference between types and complexity of wood. The innovation of the present invention is the use of cellulose paper for the extraction, analysis and quantification of NAs in wastewater from offshore oil extraction. With cellulose paper, a better interaction of the compounds of interest in the extraction is obtained, due to the lack of interfering compounds, and mainly, an analysis standard is maintained by using cellulose paper. Furthermore, the flat surface of the paper substantially increases the reproducibility of the method.

The document CN 102313658 B, entitled “Method for preparing naphthenic acid sample in wastewater”, addresses a method for preparing a sample of naphthenic acid in petroleum wastewater. The method consists of a series of steps for the extraction of naphthenic acids in water samples, thus enabling analyses to be performed for characterization. In addition to the method not being for characterization and quantification, the method in the document is extremely laborious with a series of steps. The method in the present invention shows a way to extract and analyze naphthenic acids directly and quickly, in a process of few steps.

The document WO 0248698 A1, entitled “Direct determination of acid distributions in crudes and crude fractions”, addresses a method for the direct determination of the acid distribution in crude oil and crude oil fractions by chemical ionization mass spectrometry with negative chlorine ions. The crude oil or crude oil fraction is introduced into a mass spectrometer followed by the introduction of a chlorinated reagent capable of producing chloride anions that can react with the acidic compounds of the crude oil or crude oil fractions. This method, although effective for analyzing crude oil and fractions, cannot be applied to produced water, since this wastewater, in addition to having a significant amount of organic compounds, has a high amount of salts. Due to the high amount of salts, the sample cannot be introduced directly into the mass spectrometer. The method in the present invention, however, allows the NAs to be adsorbed onto the paper cellulose in just one minute of contact with the solution, thus enabling analysis without the interference of salts.

The document in the name of Dzidic et al., entitled “Determination of Naphthenic Acids in California Crudes and Refinery Wastewaters by Fluoride Ion Chemical Ionization Mass Spectrometry”, addresses a method based on chemical ionization mass spectrometry using fluoride ions for the analysis of naphthenic acids in crude oils and wastewaters from refineries in California. The method described shows a methodology for the extraction and fractionation of crude oil, however, it does not show any methodology for extraction and sample preparation for the analysis of wastewater. Furthermore, the analysis shown in the document does not occur directly, requiring different extraction methodologies for sample preparation. The innovation of the present invention precisely shows a method in which the analysis is direct, with a simple extraction of just one minute before analyzing the sample. With this method, it was also possible to construct calibration curves for quantifying these acids, unlike this document.

The document in the name of Mapolelo et al., entitled “Characterization of naphthenic acids in crude oils and naphthenates by electrospray ionization FT-ICR mass spectrometry”, addresses a method for characterizing naphthenic acids in crude oils and naphthenates by electrospray ionization FT-ICR mass spectrometry. The method described allows the characterization of NAs in crude oils, however, as in some previous documents, the method is not capable of analyzing produced water without a rigorous extraction process such as liquid-liquid or solid phase extraction (SPE). In addition, the method also did not show the capacity for quantifying these study acids, as in the present invention.

Thus, unlike the state of the art, the present invention provides fast, direct and environmentally friendly method for analysis, characterization and direct quantification of naphthenic acids in produced water by combining mass spectrometry with PSI (paper ionization).

### SUMMARY OF THE INVENTION

The present invention provides a fast, direct and solvent-reduced method for analysis, characterization and direct quantification of naphthenic acids in produced water by paper ionization mass spectrometry.

### BRIEF DESCRIPTION OF THE FIGURES

In order to obtain a full and complete view of the objective of this invention, the figures to which references are made are shown as follows.

FIG. 1 shows a photograph indicating a support with a clamp used for the extraction of naphthenic acids in wastewater samples.

FIG. 2 shows the PSI (—) LTQ MS, where a) represents the homemade device used for the analysis; and b) positioning the paper 5 mm away from the mass spectrometer inlet.

FIG. 3 shows the experimental workflow for the analysis of NAs in water produced by NH₂—PSI-MS, in which (a) represents the modification of the paper; (b) the extraction of NAs (1 min); and (c) the analysis of NAs extracted from water produced by NH₂—PSI-MS.

FIG. 4 shows the mass spectra for the Sigma standard of NAs in seawater (200 μg·mL⁻¹) obtained in the analyses of a) PSI-MS with a not modified paper, and b) NH₂—PSI-MS (modified paper).

FIG. 5 shows a comparative graph of absolute intensities for the selected ions obtained through the PSI-MS analysis with modified and not modified paper.

FIGS. 6(A)-(E) show calibration curves for each ion studied. The x-axis corresponds to the concentration mg L⁻¹ and the y-axis to the absolute intensity.

### DETAILED DESCRIPTION OF THE INVENTION

The present invention relates to a method for analysis, characterization and direct quantification of naphthenic acids in water produced by paper ionization mass spectrometry. The method comprises the following steps:

### (a) Modification of the Cellulose Paper Surface

Laser-cut triangular cellulose papers measuring 1.5 cm on each side were used. Initially, the surface of the paper was modified with 3-aminopropyl triethoxysilane (Koga et al., 2011) to improve the ionization of the acids studied. To perform the paper modification, the cut papers were submerged for 5 min in a solution of (3-Aminopropyl) triethoxysilane (APTES) 1% in ethanol/water (80:20, v/v), and heat-treated in an oven at 110° C. for 3 h. After modification, the papers were washed with 100% ethanol to remove excess reagents and dried at room temperature.

### (b) Extraction of Naphthenic Acids

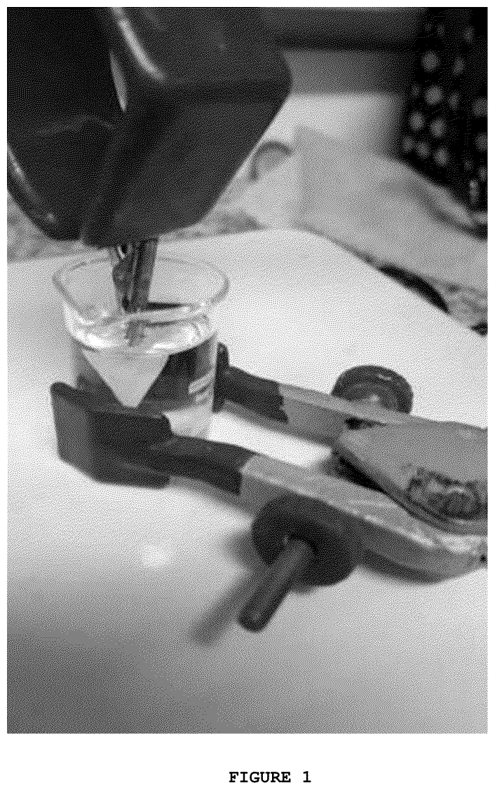

For the extraction of naphthenic acids, a homemade universal support with a clamp was used to keep the paper immersed in the analysis solution during the extraction time (1 min) (FIG. 1). After extraction, the papers were subjected to mass spectrometry analysis.

### (c) Mass Spectrometry Analysis

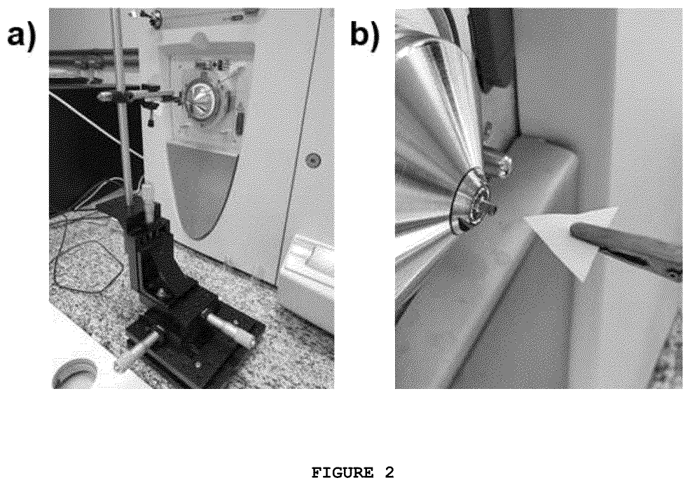

The mass spectrometer used was the LTQ XL (Thermo Scientific, Bremen, Germany) with a homemade paper ionization source (PSI) (FIG. 2a) performed in negative ionization mode. The source was fixed so that the tip of the paper was positioned at the center of the ion inlet in the mass spectrometer, 5 mm away (FIG. 2b). The experimental parameters used for all analyses were: spray voltage: 2.8 kV; capillary temperature: 275° C.; Full scan, m/z range 100 to 500.

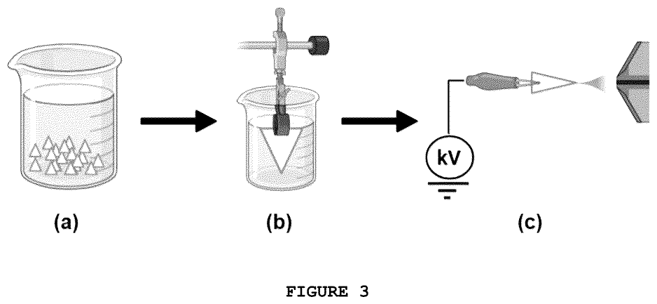

FIG. 3 shows a workflow illustrating the steps of paper modification, extraction of NAs, and direct analysis of naphthenic acids in produced water by paper ionization mass spectrometry. In the paper modification step, the cut papers are immersed in a 1% APTES solution and heat-treated in an oven at 110° C. for 3 h. Although this step lasts approximately 3 h and 5 min, it is possible to modify a large quantity of papers, enabling several analyses. After paper modification, the modified paper is submerged in the NA solution for just 1 min, where it will adsorb the NAs present in the produced water, enabling analysis. Finally, after extraction, the NAs can be directly analyzed by the NH₂—PSI-MS technique.

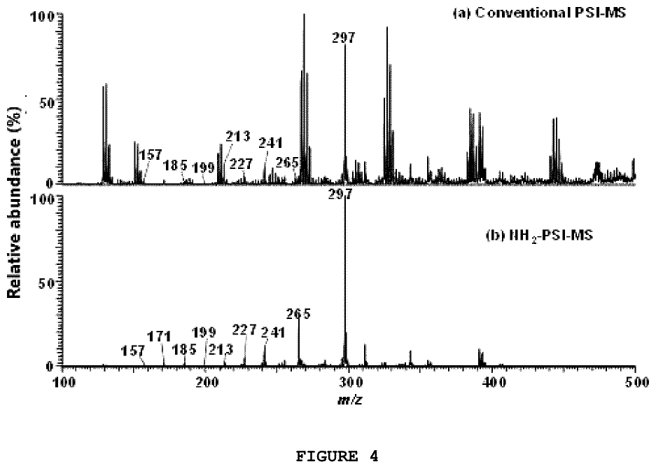

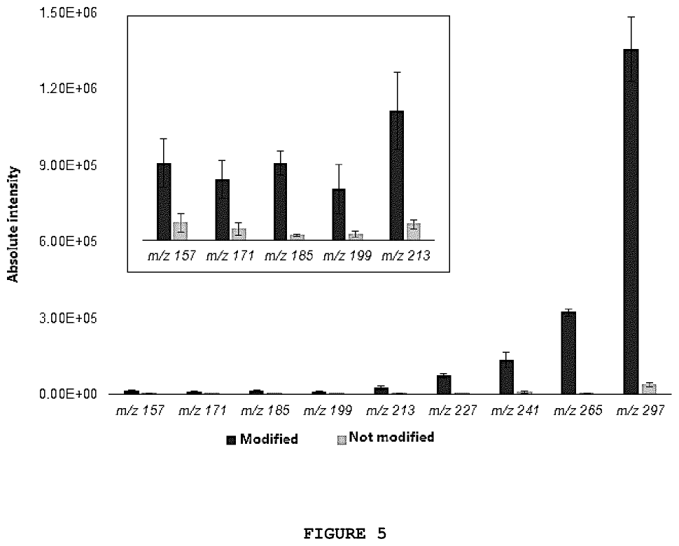

To optimize the analysis method, a standard solution of NAs purchased from Sigma Aldrich was prepared at a concentration of 200 mg L⁻¹ in filtered seawater and analyzed by PSI-MS (not modified paper) and NH₂—PSI-MS (modified paper) in order to identify an improvement in the ionization of the compounds studied with the modified paper. As can be seen in FIG. 4, due to the surface modification of the paper, it became more specific for the interaction with NAs, enabling a better ionization of these compounds, while in the analysis with the not modified paper, a greater number of NaCl clusters were visualized in the spectrum and a lower relative intensity for the compounds. To improve visualization, a graph comparing the absolute intensity of the selected ions obtained by the PSI-MS (not modified paper) and NH₂—PSI-MS (modified paper) analyses was constructed (FIG. 5). The NH₂—PSI-MS analysis showed great selectivity and sensitivity for the characterization of NAs with a rapid extraction of only 1 minute, without using solvent, and with only 10 mL of sample.

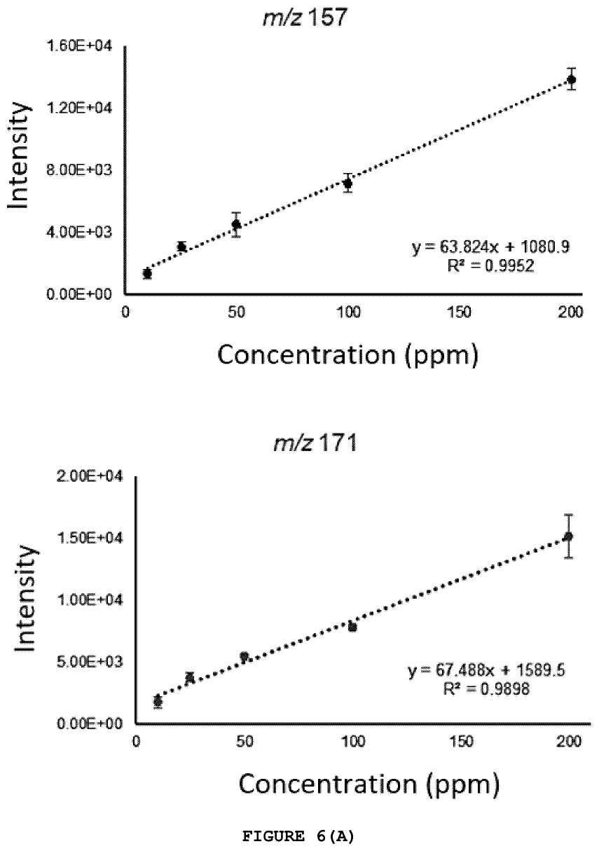

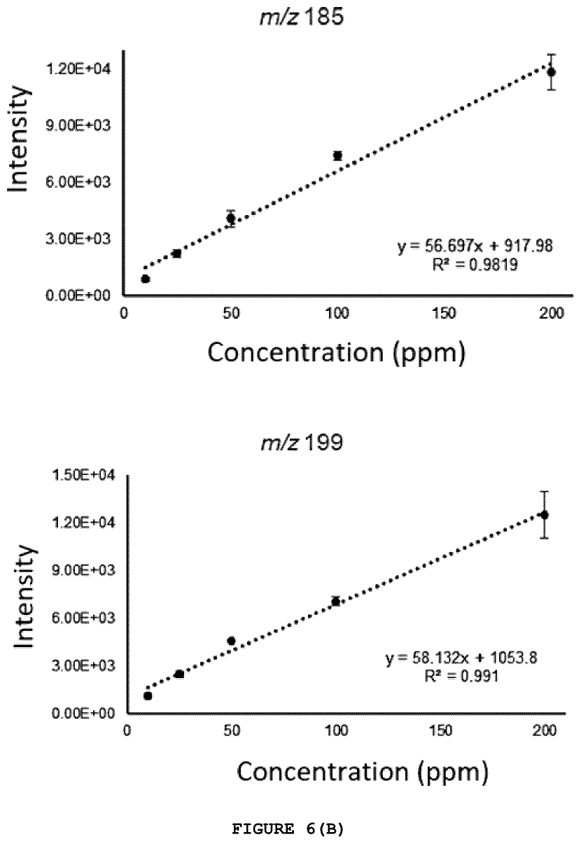

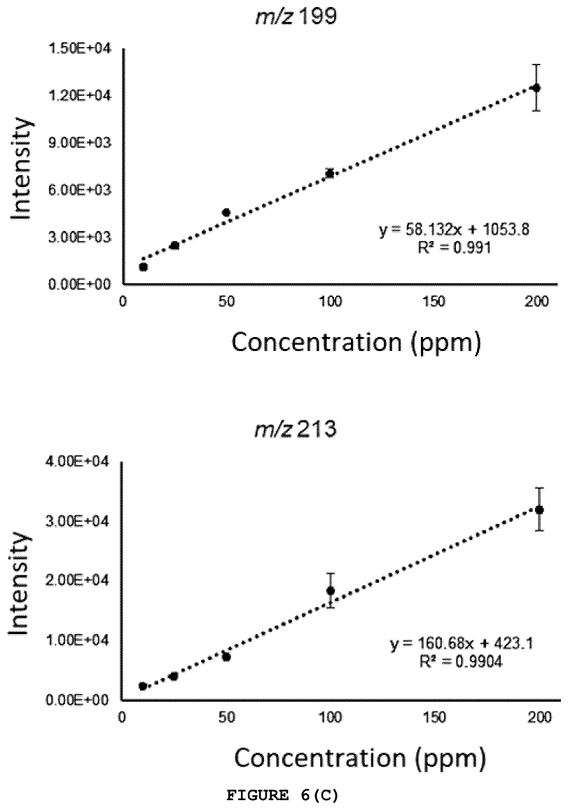

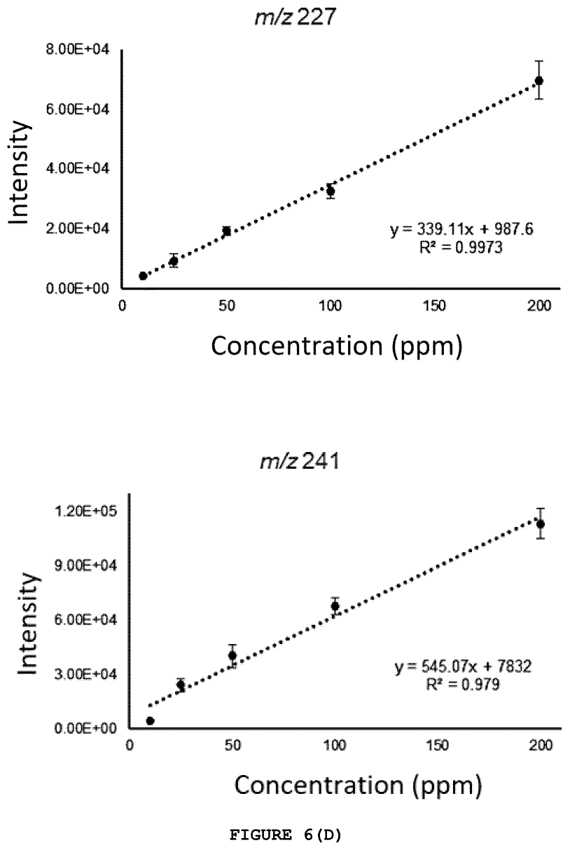

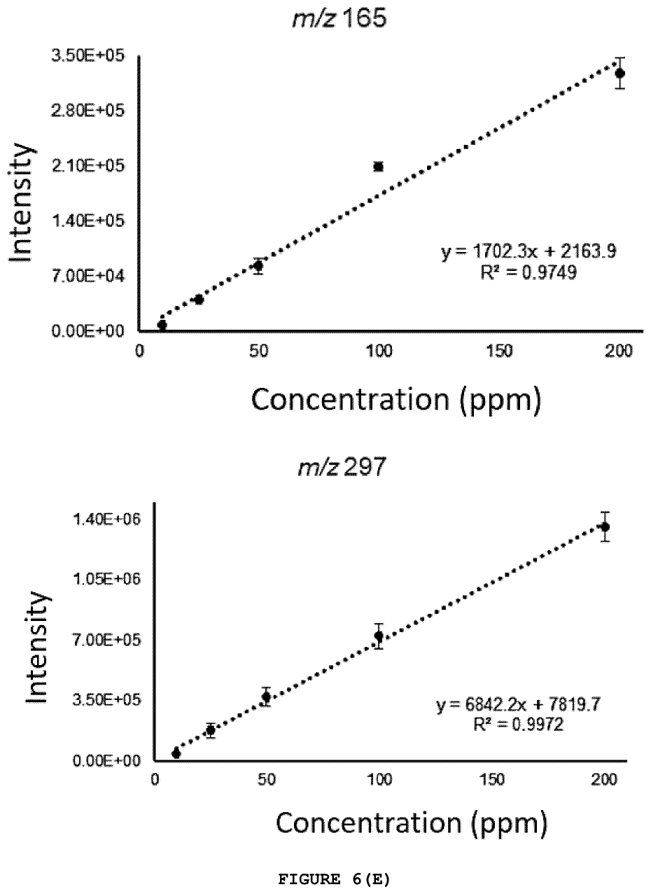

After confirming the ionization efficiency with the modification of the paper, NH₂—PSI-MS analyses were performed with 1 min of extraction in seawater doped at concentrations of 10, 25, 50, 100 and 200 mg L⁻¹ of Sigma Aldrich NAs standard to evaluate the linearity of the method for quantification of NAs. After the analyses were performed, calibration curves could be constructed for nine selected ions (FIGS. 6(A)-(E)). And the values of LOD=1 mg L⁻¹ and LOQ=10 mg L⁻¹ could be identified. Table 1 shows the equation of the straight line of each calibration curve, as well as its respective correlation coefficient for each ion. For each ion evaluated, the calibration curve showed good linearity.

Table 1. Relationship between each m/z with the equation of the straight line of each calibration curve and their respective correlation coefficients (R²).

| m/z | Equation of the straight line | R² |
|---|---|---|
| 157 | y = 63.824x + 1080.9 | 0.9952 |
| 171 | y = 67.488x + 1589.5 | 0.9898 |
| 185 | y = 56.697x + 917.98 | 0.9819 |
| 199 | y = 58.132x + 1053.8 | 0.9910 |
| 213 | y = 160.68x + 423.1 | 0.9904 |
| 227 | y = 339.11x + 987.6 | 0.9973 |
| 241 | y = 545.07x + 7832 | 0.9790 |
| 265 | y = 1702.3x + 2163.9 | 0.9749 |
| 297 | y = 6842.2x + 7819.7 | 0.9972 |

Three controls at concentrations of 20, 75 and 150 mg L⁻¹ were used to validate the method. The three controls were extracted and analyzed by NH₂—PSI-MS, and their ions were quantified using the calibration curves found. It can be noted that the study was performed in intraday and interday triplicate, and both showed quite satisfactory recovery and precision results (precision below 15% and recovery of 81 to 120), which contributed to the robustness of the method.

Thus, it can be seen that the method shows a way to extract NAs from offshore oil industry wastewater in just 1 minute and allows direct analysis by ionization mass spectrometry on cellulose paper. The method is fast (1 minute of extraction), does not use solvent for extraction, and can be performed with a small amount of residual sample (10 mL), unlike the volume currently used by the industry (500 mL).

Furthermore, the not method only enables sample characterization, but also enables quantification of NAs in produced water.

### APPLICABILITY OF THE INVENTION

The method for characterizing and quantifying NAs in produced water by NH₂—PSI-MS can be easily employed in wastewater from the offshore and onshore petrochemical industry, enabling rapid, inexpensive and environmentally friendly analysis (with almost no use of organic solvents) for the treatment and proper disposal of wastewater, minimizing problems related to corrosion n pipes and toxicity to the aquatic environment.

The invention enables direct and rapid analysis for the characterization and quantification of NAs in produced water from the petrochemical industry. The method has advantages such as: 1) Drastic reduction in extraction and analysis time, since liquid-liquid extractions and SPE can take more than hours to perform, while in this method, only one minute is needed to extract the NAs before analysis by high-resolution mass spectrometry; 2) Reduction in the use of organic solvents, since the extraction method does not use organic solvents, and the NH₂—PSI-MS analysis uses an extremely reduced amount of solvent (less than 1 mL per analysis) compared to methods such as LC-MS; 3) Cost reduction because the method requires only modified paper (modifying the paper has a low cost, and with less than 3 hours of synthesis it is possible to produce enough paper for more than 1 analysis) and methanol (less than 1 mL per analysis), while other extraction and analysis methods will use a large amount of organic solvents, SPE cartridges, chromatographic columns and more working hours by the technician responsible for the analyses.

In some examples, the present disclosure may involve one or more of the following clauses:
Clause 1. A method for analysis, characterization and direct quantification of naphthenic acids in produced water, comprising:
(a) modification of a surface of a cellulose paper;
(b) extraction of the naphthenic acids; and
(c) analysis by mass spectrometry with ionization on paper (NH₂—PSI-MS).
   Clause 2. The method, according to clause 1, wherein the modification of the surface of the cellulose paper is carried out with (3-aminopropyl) triethoxysilane (APTES), and wherein the cellulose paper is cut and submerged for 5 min in a solution of 1% APTES in ethanol/water (80:20, v/v), heat-treated in an oven at 110° C. for 3 hours, and washed with 100% ethanol to remove excess reagents and dried at room temperature.
   Clause 3. The method, according to clause 1, wherein the extraction of the naphthenic acids is performed using a homemade universal support with a clamp in order to keep the cellulose paper immersed in the produced water comprising naphthenic acids during the extraction time.
   Clause 4. The method, according to clause 1, wherein the analysis is performed in a mass spectrometer with a cellulose paper ionization source (NH₂—PSI-MS) with the following parameters: spray voltage: 2.8 kV; capillary temperature: 275° C.; full scan, m/z range 100 to 500.
   Clause 5. The method, according to clause 2, wherein the cellulose paper is laser-cut with a size of 1.5 cm on each side.
   Clause 6. The method, according to clause 3, wherein the cellulose paper is immersed in the produced water comprising naphthenic acids for 1 min.

1. A method for analysis, characterization and direct quantification of naphthenic acids in produced water, comprising:
(a) modification of a surface of a cellulose paper;
(b) extraction of the naphthenic acids; and
(c) analysis by mass spectrometry with ionization on paper (NH₂—PSI-MS).

2. The method, according to claim 1, wherein the modification of the surface of the cellulose paper is carried out with (3-aminopropyl) triethoxysilane (APTES), and wherein the cellulose paper is cut and submerged for 5 min in a solution of 1% APTES in ethanol/water (80:20, v/v), heat-treated in an oven at 110° C. for 3 hours, and washed with 100% ethanol to remove excess reagents and dried at room temperature.

3. The method, according to claim 1, wherein the extraction of the naphthenic acids is performed using a homemade universal support with a clamp in order to keep the cellulose paper immersed in the produced water comprising naphthenic acids during the extraction time.

4. The method, according to claim 1, wherein the analysis is performed in a mass spectrometer with a cellulose paper ionization source (NH₂—PSI-MS) with the following parameters: spray voltage: 2.8 kV; capillary temperature: 275° C.; full scan, m/z range 100 to 500.

5. The method, according to claim 2, wherein the cellulose paper is laser-cut with a size of 1.5 cm on each side.

6. The method, according to claim 3, wherein the cellulose paper is immersed in the produced water comprising naphthenic acids for 1 min.
